(19) United States
(12) Patent Application Publication
(10) Pub. No.: US 2024/0391130 A1
(43) Pub. Date: Nov. 28, 2024

(54) Hand-Held Power Tool Having a Clamping Element and a Clamping Element Operating Unit Which Can be Actuated Without Tools, and a Method for Clamping an Insertion Tool Having a Clamping Element Operating Unit that Can be Actuated Without Tools

(71) Applicant: Robert Bosch GmbH, Stuttgart (DE)

(72) Inventor: Thorsten Kuehn, Eislingen (DE)

(21) Appl. No.: 18/673,644

(22) Filed: May 24, 2024

(30) Foreign Application Priority Data
May 25, 2023 (DE) 10 2023 204 906.6

(51) Int. Cl. B27C 5/10

(52) U.S. Cl. CPC B27C 5/10

(57) ABSTRACT

A hand-held power tool, in particular a router, includes a tool holder and a housing in which at least one drive unit configured to drive the tool holder is arranged. The tool holder is associated with a clamping element configured to clamp an insertion tool configured to be arranged in the tool holder. The clamping element is configured to clamp the insertion tool in the tool holder in a clamping position and release the insertion tool in a release position. A clamping element operator unit configured to be actuated without tools is provided to enable tool-free actuation of the clamping element to clamp or release the insertion tool in/from the tool holder.

This application claims priority under 35 U.S.C. § 119 to application no. DE 10 2023 204 906.6, filed on May 25, 2023 in Germany, the disclosure of which is incorporated herein by reference in its entirety.

The present disclosure relates to a hand-held power tool, in particular, a router, having a tool holder and a housing, in which at least one drive unit for driving the tool holder is arranged, wherein the tool holder is associated with a clamping element for clamping an insertion tool which can be arranged in the tool holder, and wherein the clamping element clamps the insertion tool in the tool holder in a clamping position and releases the insertion tool in a release position.

### BACKGROUND

Such a hand-held power tool configured as a router with a tool holder is known from the prior art. The tool holder is driven by a drive unit arranged in a housing of the router. A clamping element is provided for clamping an insertion tool which can be arranged in the tool holder. In a clamping position, the clamping element clamps the insertion tool in the tool holder and in a release position, the clamping element releases the insertion tool. The clamping element is arranged in the clamping position or the release position by means of a separate tool, e.g., an open-ended wrench.

### SUMMARY

The disclosure relates to a hand-held power tool, in particular, a router, having a tool holder and a housing, in which at least one drive unit for driving the tool holder is arranged, wherein the tool holder is associated with a clamping element for clamping an insertion tool which can be arranged in the tool holder, and wherein the clamping element clamps the insertion tool in the tool holder in a clamping position and releases the insertion tool in a release position. A clamping element operating unit which can be actuated without tools is provided to allow tool-free actuation of the clamping element to clamp or release the insertion tool in/from the tool holder.

The disclosure thus makes it possible to provide a hand-held power tool, in particular a router, in which a secure and fast arrangement of the clamping element in the clamping position or the release position can be enabled by the clamping element operating unit which can be actuated without tools.

Preferably, the clamping element operating unit comprises a blocking element, which is configured to block the clamping element on the housing in a rotationally fixed manner in a blocking position, in order to prevent a common rotational movement of the tool holder and the clamping element, and to release the clamping element in a release position in order to allow common rotational movement of the tool holder and the clamping element.

The blocking element makes it simple to arrange the clamping element in the blocking position or in the release position.

Preferably, a switch is provided for activating a rotational movement of the drive unit, wherein the blocking element actuates the switch in the blocking position to allow the clamping element to be arranged in the release position in a preset first direction of rotation when the drive unit rotates and to allow the clamping element to be arranged in the clamping position in a preset second direction of rotation when the drive unit rotates.

The interaction between the blocking element and the switch makes it simple and straightforward to arrange the clamping element in the release position or in the clamping position.

Preferably, an electronic unit is provided for controlling the drive unit in a working mode at a first speed and in a clamp-release mode at a second speed, wherein the second speed is less than the first speed, and wherein the switch is connected to the electronic unit to allow a rotational movement of the drive unit in the clamp-release mode via the electronic unit.

Thus, the drive unit can be safely and reliably switched between a working mode and a clamp-release mode.

The clamping element operator unit preferably comprises an actuating element for actuating the blocking element to allow the blocking element to be moved from the release position to the blocking position.

This makes it simple and straightforward to actuate the blocking element using the actuating element.

According to one embodiment, the clamping element operating unit comprises contact protection.

This reliably prevents unintentional manual actuation of the clamping element and any resulting injury in the event of unintentional contact when clamping or releasing an insertion tool in the tool holder.

Preferably, the contact protection is box-shaped and has an internal space in which the blocking element, the clamping element, and the switch are arranged.

This provides stable and robust protection for the blocking element, the clamping element, and the switch.

In addition, the present disclosure relates to a method for clamping an insertion tool in a tool holder of a hand-held power tool, in particular a router, with a clamping element operating unit which can be actuated without tools according to the disclosure, wherein the method comprises the following steps:
actuating the actuating element of the clamping element operating unit to arrange the clamping element in the release position,
arranging the insertion tool in the tool holder, and
actuating the actuating element to arrange the clamping element in the clamping position for clamping the insertion tool in the tool holder.

The disclosure thus makes it possible to provide a method for clamping an insertion tool in which a secure and fast arrangement of the clamping element in the clamping position or the release position can be enabled by the clamping element operating unit which can be actuated without tools.

Preferably, when the actuation element is actuated, the clamping element is blocked by the blocking element relative to the tool holder on the housing in a rotationally fixed manner.

Thus, by actuating the actuating element, the blocking element may be easily and straightforwardly actuated to arrange the clamping element in the blocking position or the release position.

Preferably, when actuating the actuating element, the switch is activated for activating a rotational movement of the drive unit in a preset first direction of rotation to arrange the clamping element in the release position and when the drive unit rotates, is activated in a preset second rotation direction to arrange the clamping element in the clamping position.

This enables safe and reliable activation of a working mode and a clamp-release mode.

Preferably, when the clamping position is reached by the clamping element, a blocking current is generated, wherein the electronic unit disables the drive unit in response to the generation of the blocking current.

Thus, in a simple manner, an unintentional increase in current that can destroy the drive unit can be prevented during a clamping operation.

### BRIEF DESCRIPTION OF THE DRAWINGS

The disclosure is explained in more detail in the following description with reference to the exemplary embodiments shown in the drawings. Shown are:

FIG. 1 a side perspective view of a hand-held power tool with a clamping element control unit which can be actuated without tools according to the disclosure, and

FIG. 2 a section of a longitudinal cross-section through the hand-held power tool of FIG. 1.

### DETAILED DESCRIPTION

Elements having the same or a comparable function are provided with the same reference characters in the drawings and are described in detail only once.

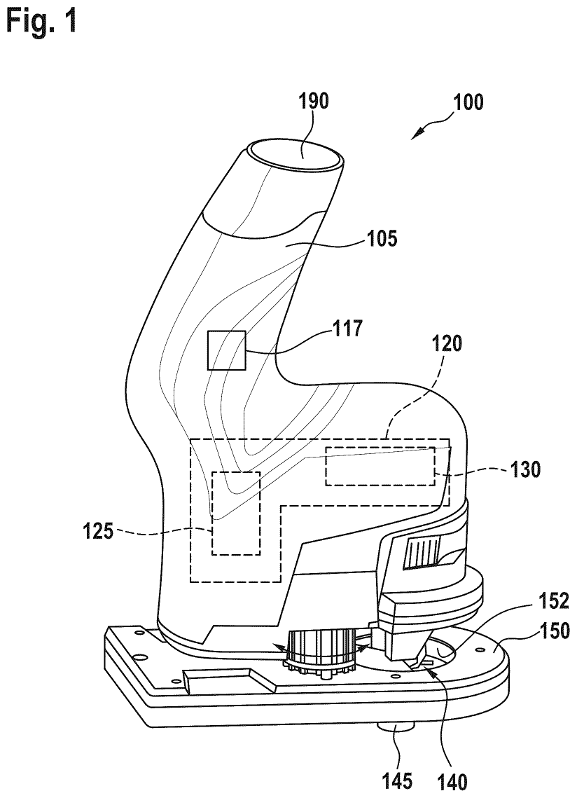

FIG. 1 shows a hand-held power tool 100 that is designed as a router. The hand-held power tool 100 has a housing 105. Preferably a drive unit 120 for driving a tool holder 140 is arranged in the housing 105. Preferably, the drive unit 120 is associated with at least one drive motor 125. According to one embodiment, the drive motor 125 is an electronically commutated motor. Optionally, the drive unit 120 is associated with a transmission 130.

The drive unit 120 or the drive motor 125 can preferably be switched on and off via a manual switch 117. The manual switch 117 is preferably arranged on the housing 105.

The tool holder 140 is configured to receive an insertion tool 145. The insertion tool 145 is preferably configured as a milling tool, in particular as a trimmer and/or round milling cutter.

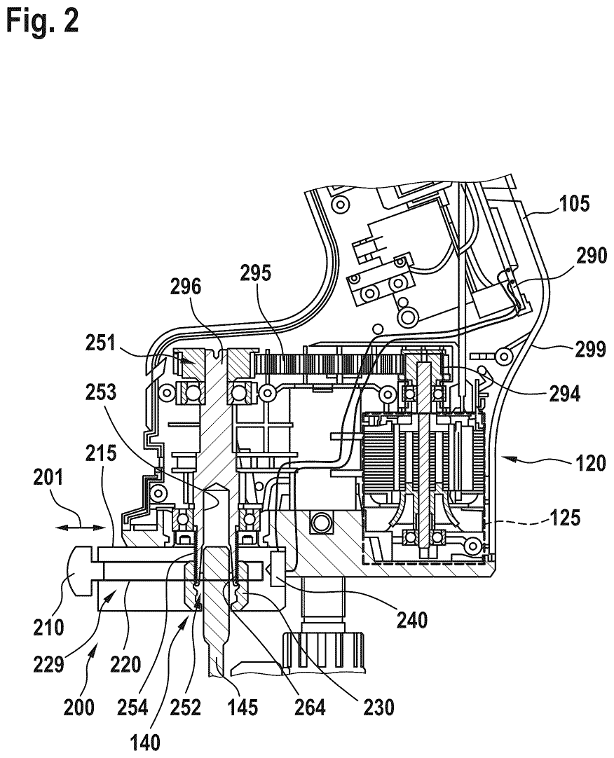

The tool holder 140 is associated with a clamping element (230 in FIG. 2) for clamping the insertion tool 145 that can be arranged in the tool holder 140. Preferably, the clamping element (230 in FIG. 2) clamps the insertion tool 145 in the tool holder 140 in a clamping position and releases the insertion tool 145 in a release position.

Moreover, a battery pack 190 is preferably arranged in the housing 105, at least in sections, wherein the battery pack 190 is provided for powering the hand-held power tool 100. It is noted, however, that the hand-held power tool 100 may also be operated via a wired power supply, e.g., via a mains line.

Furthermore, the hand-held power tool 100 preferably has a base plate 150 for guiding the hand-held power tool 100 on a workpiece surface. Preferably, the base plate 150 has a recess 152 through which the insertion tool 145 extends at least in sections.

FIG. 2 shows a section of the hand-held power tool 100 of FIG. 1 with the housing 105 open. Preferably, the housing 105 comprises two housing half-shells 299, wherein only one housing half-shell 299 is shown in FIG. 2. FIG. 2 illustrates a preferably parallel arrangement of the drive motor 125 with an output shaft 296. The drive motor 125 preferably drives the output shaft 296. For this purpose, a drive shaft 294 is associated with the drive motor 125. In accordance with one embodiment, a belt 295 is provided that operatively connects the output shaft 296 to the drive shaft 294.

The output shaft 296 has a first illustrative upper end 251 and a second illustrative lower end 252. Preferably, the first end 251 is driven via the belt 295 and the tool holder 140 is arranged at the second end 252. For this purpose, the output shaft 296 at the second end 252 comprises an internal receptacle 253 for receiving an insertion tool 145 in sections. Furthermore, the output shaft 296 has an external thread 254 at its second end 252, wherein the external thread 254 is operatively connected to an internal thread 264 of a clamping element 230 associated with the tool holder 140.

The clamping element 230 is configured to clamp the insertion tool 145 of FIG. 1 which can be arranged in the tool holder 140, in particular in the internal receptacle 253. Here the clamping element 230 clamps the insertion tool 145 in the tool holder 140 or the internal receptacle 253 in a clamping position and releases the insertion tool 145 in a release position. Illustratively, the clamping element 230 is configured as a collet. Here, the clamping element 230 configured as a collet is preferably moved along the outer thread 254 towards or away from the first end 251 of the output shaft 296. In the release position, the insertion tool 145 may be removed from or arranged in the tool holder 140. It is noted that the clamping element 230 may also be configured as a clamping nut or any other clamping element for clamping an insertion tool in a tool holder.

According to the disclosure, a clamping element operator unit 200 which can be actuated without tools is provided to allow tool-free actuation of the clamping element 230 to clamp or release the insertion tool 145 in/from the tool holder 140.

Preferably, the clamping element operating unit 200 comprises a blocking element 220 configured to arrange the clamping element 230 in a blocking position and a release position. In the blocking position, the clamping element 230 is blocked on the housing 105 in a rotationally fixed manner to prevent common rotational movement of the tool holder 140 and the clamping element 230. In the release position, the clamping element 230 is released to allow a common rotational movement of the tool holder 140 and the clamping element 230.

Preferably, a switch 240 is provided for activating rotational movement of the drive unit 120. Preferably the blocking element 220 actuates the switch 240 in the blocking position to allow the clamping element 230 to be arranged in the release position in a preset first direction of rotation when the drive unit 120 rotates and to allow the clamping element 230 to be arranged in the clamping position in a preset second direction of rotation when the drive unit 120 rotates. Preferably, the preset first direction of rotation is a counterclockwise rotation and the preset second direction is a clockwise rotation.

According to one embodiment, an electronic unit 290 is provided for controlling the drive unit 120 in a working mode at a first speed and in a clamp-release mode at a second speed. Here, the electronic unit 290 controls a setting of the operation mode, i.e., the working mode or the clamp-release mode, as well as a setting of the associated speed. Preferably, the second speed is less than the first speed. By way of example, the first speed is 20,000 to 30,000 revolutions per minute and the second speed is 100 revolutions per minute. Preferably, the switch 240 is connected to the electronic unit 290 to allow activation of rotational movement of the drive unit 120 in the clamp-release mode via the electronic unit 290.

In addition, the clamping element operator 200 unit comprises an actuating element 210 for actuating the blocking element 220 to allow the blocking element 220 to be moved from the release position to the blocking position. Preferably, the movement is in the direction of an arrow 201. Alternatively, the actuating element 210 can also be actuated via a suitable application or app. For this purpose, the hand-held power tool 100 is coupled to an external device, e.g., a smartphone on which the app is installed.

Furthermore, the clamping element operating unit 200 comprises contact protection 215. Preferably, the contact protection 215 is box-shaped and has an internal space 229. Preferably the blocking element 220, the clamping element 230, and the switch 240 are arranged in the internal space 229.

To clamp the insertion tool 145 in the tool holder 140, actuation of the actuating element 210 of the clamping element operator unit 200 is first required to arrange the clamping element 230 in the release position. When the clamping element 230 is in the release position, the insertion tool 145 can be arranged in the tool holder 140. After arranging the insertion tool 145 in the tool holder 140, actuation of the actuating element 210 to arrange the clamping element 230 in the clamping position for clamping the insertion tool 145 in the tool holder 140 is required.

Preferably, when the actuating element 210 is actuated, the clamping element 230 is blocked by the blocking element 220 relative to the tool holder 140 on the housing 105 in a rotationally fixed manner. As a result, when the drive unit 120 is actuated, the clamping element 230 may rotate along the external thread 254 to the release position or the clamping position. Here, as described above, when the actuating element 210 is actuated, the switch 240 is activated to activate a rotational movement of the drive unit 120 in the preset first rotational direction to arrange the clamping element 230 in the release position and when the drive unit 120 rotates, is activated in the preset second rotational direction to arrange the clamping element 230 in the clamping position. When the clamping position is reached by the clamping element 230, a blocking current is preferably generated, wherein the electronic unit 290 disables the drive unit 120 in response to the generation of the blocking current.

According to one embodiment, a transmission is provided, e.g., the transmission 130 of FIG. 1, to increase a torque generated by the drive unit in at least the clamp-release mode. The transmission is preferably designed as a planetary gear train. Preferably, a coupling unit is provided to connect the transmission to the output shaft 296 in the clamp-release mode and to disconnect it in the working mode. Here, according to one embodiment, the output shaft 296 may be moved to adjust the particular mode. For this purpose, the output shaft 296 may have a cone at its first end 251.

1. A hand-held router, comprising:
a tool holder; and
a housing in which at least one drive unit configured to drive the tool holder is arranged, wherein
the tool holder is associated with a clamping element configured to clamp an insertion tool configured to be arranged in the tool holder,
the clamping element is configured to clamp the insertion tool in the tool holder in a clamping position and release the insertion tool in a release position, and a clamping element operator unit configured to be actuated without tools is provided to enable tool-free actuation of the clamping element to clamp or release the insertion tool in/from the tool holder.

2. The hand-held power tool according to claim 1, wherein the clamping element operating unit comprises a blocking element which is configured to block the clamping element on the housing in a rotationally fixed manner in a blocking position, to prevent a common rotational movement of the tool holder and the clamping element, and to release the clamping element in a release position to allow a common rotational movement of the tool holder and the clamping element.

3. The hand-held power tool according to claim 2, wherein:
a switch is configured to activate a rotational movement of the drive unit; and
the blocking element is configured to actuate the switch in the blocking position, such that the clamping element is arranged in the release position in a preset first direction of rotation when the drive unit rotates and such that the clamping element is arranged in the clamping position in a preset second direction of rotation when the drive unit rotates.

4. The hand-held power tool according to claim 3, wherein:
an electronic unit is configured to control the drive unit in a working mode at a first speed and in a clamp-release mode at a second speed;
the second speed is less than the first speed; and
the switch is connected to the electronic unit, to allow a rotational movement of the drive unit in the clamp-release mode via the electronic unit.

5. The hand-held power tool according to claim 2, wherein the clamping element operating unit comprises an actuating element configured to actuate the blocking element such that the blocking element is moved from the release position to the blocking position.

6. The hand-held power tool according to claim 1, wherein the clamping element operating unit comprises contact protection.

7. The hand-held power tool according to claim 6, wherein the contact protection is box-shaped and has an internal space in which the blocking element, the clamping element, and the switch are arranged.

8. A method for clamping an insertion tool in a tool holder of a hand-held router, with a clamping element operator unit which can be actuated without tools according to claim 1, comprising:
actuating an actuating element of the clamping element operating unit to arrange the clamping element in the release position;
arranging the insertion tool in the tool holder; and
further actuating the actuating element to arrange the clamping element in the clamping position to clamp the insertion tool in the tool holder.

9. The method according to claim 8, wherein the clamping element is blocked in a rotationally fixed manner relative to the tool holder on the housing by a blocking element when the actuating element is actuated and when the actuating element is further actuated.

10. The method according to claim 8, wherein:
when actuating the actuating element, a switch is activated to activate a rotational movement of the at least one drive unit in a preset first direction of rotation to arrange the clamping element in the release position; and
when the at least one drive unit rotates, is activated in a preset second rotation direction to arrange the clamping element in the clamping position.

11. The method according to claim 9, wherein:
when the clamping position is reached by the clamping element, a blocking current is generated; and
the electronic unit disables the at least one drive unit in response to the generation of the blocking current.
